(19) United States
(12) Patent Application Publication
(10) Pub. No.: US 2026/0151767 A1
(43) Pub. Date: Jun. 4, 2026

(54) MICROFLUIDIC DILUTION REFRIGERATOR ON A CHIP

(71) Applicant: The Regents of the University of California, Oakland, CA (US)

(72) Inventor: Benjamin Mazin, Santa Barbara, CA (US)

(73) Assignee: The Regents of the University of California, Oakland, CA (US)

(21) Appl. No.: 19/135,432

(22) PCT Filed: Dec. 11, 2023
(86) PCT No.: PCT/US2023/083307

§ 371 Date: Jun. 4, 2025

Related U.S. Application Data
(60) Provisional application No. 63/432,234, filed on Dec. 13, 2022.
(60) Provisional application No. 63/483,796, filed on Feb. 8, 2023.

(51) Int. Cl. B01L 3/00

(52) U.S. Cl. CPC B01L 3/50273; B01L 3/502707; B01L 2200/0689; B01L 2200/12; B01L 2300/087; B01L 2300/0896; B01L 2300/14; B01L 2300/185; B01L 2400/043

(57) ABSTRACT

A microfluidic dilution refrigerator comprising a microfluidic system including a mixing chamber, wherein helium-3 dissolves in helium-4 to form a mixture absorbing heat, thereby cooling a device in thermal contact with the mixing chamber; a still wherein the helium-3 in the mixture evaporates from the mixture; and a heat exchanger thermally coupled to the still. The system further comprises a first microfluidic channel guiding the helium-3 from the heat exchanger to the mixing chamber, the first microfluidic channel dimensioned to control flow rate of the helium-3 into the mixing chamber; and a second microfluidic channel guiding the mixture from the mixing chamber to the still. A pumping system is provided for circulating the helium-3 from the still and back into the mixing chamber via the heat exchanger. Devices cooled by the MDR include a quantum sensor or a quantum processor in a quantum computer for performing operations on a qubit.

### CROSS REFERENCE TO RELATED APPLICATIONS

This application claims the benefit under 35 U.S.C. Section 119(e) of the following co-pending and commonly-assigned applications:

U.S. Provisional Application Ser. No. 63/432,234, filed on Dec. 13, 2022, by Benjamin Mazin, entitled “MICROFLUIDIC DILUTION REFRIGERATOR ON A CHIP,” attorneys' docket number G&C 30794.0832USP1 (UC 2023-871-1); and

U.S. Provisional Application Ser. No. 63/483,796, filed on Feb. 8, 2023, by Benjamin Mazin, entitled “MICROFLUIDIC DILUTION REFRIGERATOR ON A CHIP,” attorneys' docket number G&C 30794.0832USP2 (UC 2023-871-2);
which applications are incorporated by reference herein.

### BACKGROUND OF THE INVENTION

### 1. Field of the Invention

The present disclosure relates to microfluidic dilution refrigerators and methods of making the same.

### 2. Description of the Related Art

(Note: This application references a number of different publications as indicated throughout the specification by one or more reference numbers in brackets, e.g., [x]. A list of these different publications ordered according to these reference numbers can be found below in the section entitled “References.” Each of these publications is incorporated by reference herein.)

Quantum computers operating at room temperature need to operate at optical wavelengths to avoid thermal population of their qubit states (hv>>k_{B}T). Qubits manipulated using hv<k_{B}T (e.g., superconducting qubits) on the other hand, need to be operated at low temperatures to avoid thermal population of their qubit states. Nonetheless, despite the current challenges of reaching low temperatures, low temperature quantum computers are a more likely commercial implementation due to the relative ease of manipulating electrons in low temperature systems (as compared to photons at room temperature). However, conventional cooling systems (such as dilution refrigerators) are large and costly, and thus more practical cooling methods for reaching these low temperatures are needed. The present invention satisfies this need.

### SUMMARY OF THE INVENTION

The present invention discloses a microfluidic dilution refrigerator (MDR) that is a microfluidic system including: a mixing chamber where helium-3 (also referred to herein as ³He) dissolves in helium-4 (also referred to herein as ⁴He) to form a mixture absorbing heat, thereby cooling a device in thermal contact with the mixing chamber; a still where the helium-3 in the mixture evaporates from the mixture; and a heat exchanger thermally coupled to the still. The system further includes a first microfluidic channel guiding the helium-3 from the heat exchanger to the mixing chamber, where the first microfluidic channel is dimensioned to control a flow rate of the helium-3 into the mixing chamber; and a second microfluidic channel guiding the mixture from the mixing chamber to the still. A pumping system is provided for circulating the helium-3 from the still and back into the mixing chamber via the heat exchanger. Example devices being cooled by the MDR include, but are not limited to, a quantum sensor or a quantum processor in a quantum computer for performing operations on a qubit.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1 is a block diagram of a dilution cooling loop in a conventional dilution refrigerator, from Oxford's Principles of Dilution Refrigeration.

FIG. 2 is a block diagram of an MDR according to one or more embodiments of the present invention.

FIG. 3 is a flowchart illustrating a method of making an MDR.

FIG. 4A is an image of the turbine section of a micro-turbo-molecular pump made of micromachined silicon, FIG. 4B is a magnified portion of the image of FIG. 4A, and FIG. 4C is an image of a 28 stage diaphragm pump from the same program.

FIG. 5 is a rendering of a 3D model of a 80×20×3 mm MDR.

FIG. 6 is a block diagram of an example MDR coupled to sorption pumps.

FIGS. 7A and 7B are graphs of Melting Temperature T_{M} (mK) vs. Flow Rate (μmol/s) that illustrate the cooling power for near 100 mK including a heat load from viscous heating for heat exchanger lengths of 3 m and 2 m, respectively. A heat exchanger length of 3 m represents an upper limit of plausibility, while 2 m is more realistic given the original chip dimensions.

FIGS. 8A and 8B are graphs of T_{M} (mK) vs. Flow Rate (μmol/s) that illustrate the cooling power for near base temperature for 2 m and 3 m long heat exchangers.

FIG. 9 is a fluent simulation of an approximately 1.2 meter long heat exchanger. T³ Kapitza resistance is crudely included by dividing the heat exchanger into four of different interfacial resistance. The concentrated phase enters at 2 K is cooled to 915 mK by the time it reaches the mixing chamber.

### DETAILED DESCRIPTION OF THE INVENTION

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

### Technical Description

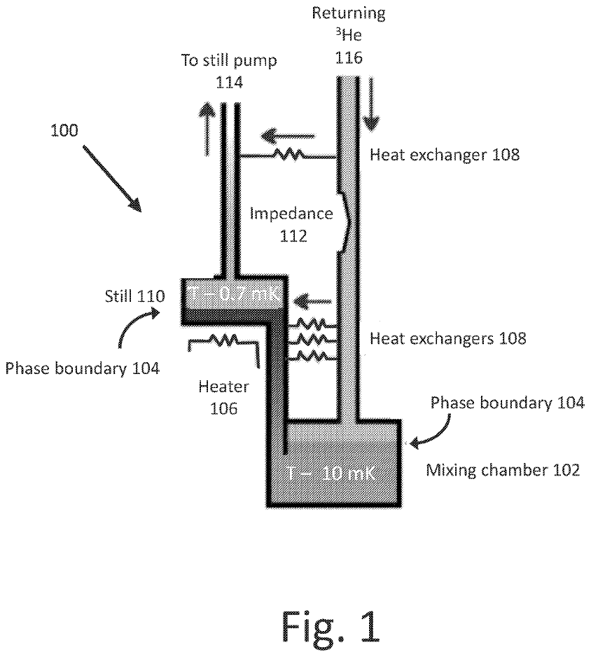

FIG. 1 illustrates a conventional dilution refrigerator 100 that can be used to cool a superconducting quantum computer, where the conventional dilution refrigerator 100 includes a mixing chamber 102 showing a phase boundary 104 for the mixture of ³He and ⁴He, heater 106, heat exchangers 108, still 110 also showing a phase boundary 104 for the mixture of ³He and ⁴He, impedance 112, conduit 114 to a still pump (not shown), and pulse tube 116 for returning ³He to the mixing chamber 102.

The dilution refrigerator 100 is comprised of a mechanical cooler, usually the pulse tube 116, for cooling to roughly 4 Kelvin (K), coupled to a dilution cooling system evaporating ³He from a mixture of ³He and ⁴He to further cool below 4 K. The mixture is recirculated in a cooling loop driven by large, powerful room temperature pumps (not shown), usually a turbo-molecular pump backed up by a dry scroll pump. Great care is taken to thermalize the incoming mixture and to thermally isolate the various stages of the dilution refrigerator 100.

Commercial dilution refrigerators for quantum computers are typically adapted for cooling large connectorized components (RF wiring, attenuators, isolators, diplexers, parametric amplifiers, etc.) to scale qubit counts. However, it is believed this approach is flawed and that true scaling to useful qubit counts requires on-chip large scale integration rather than implementation of connectorized components. While full on-chip integration may increase fabrication complexity, this disadvantage is outweighed by significant benefits in size and vast improvements in wiring scaling and readout integration. It is believed fully integrated quantum processors, with their much lower size and cooling power requirements, are a more viable path towards commercial quantum computing, if they can be combined with a compact, low power, affordable cryogenic cooler, as described herein. A cooler as described herein would also have applications in many other fields, such as quantum sensing and space-based applications (with a slightly modified design to account for the lack of gravity [1]) where the cooling requirements are a major constraint. The present invention provides a revolutionary approach for cryogenics in field applications.

### Example Microfluidic Dilution Refrigerator

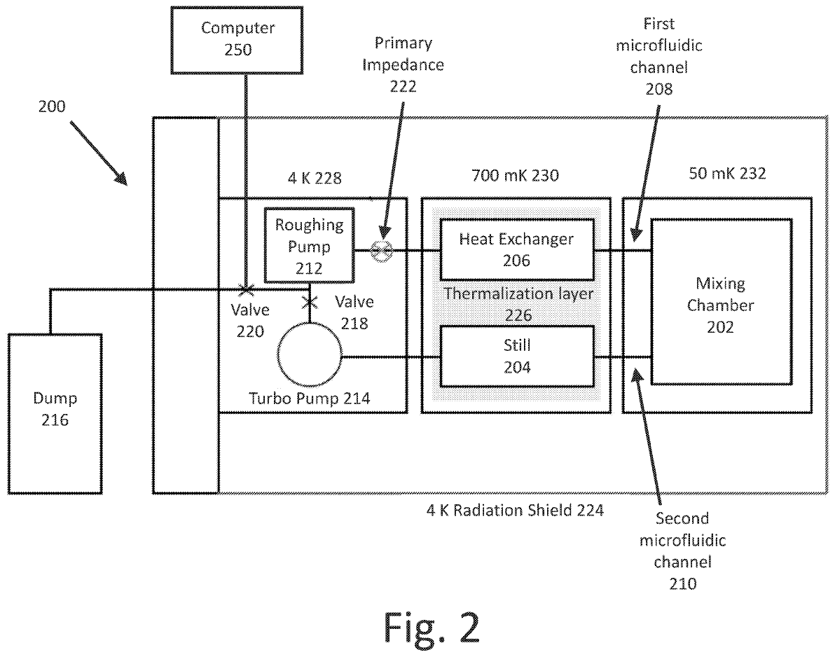

FIG. 2 illustrates a microfluidic dilution refrigerator (MDR) 200 according to one or more embodiments of the present invention. The MDR 200 is a microfluidic system comprising a mixing chamber 202, where helium-3 dissolves in helium-4 to form a mixture absorbing heat so as to cool a device in thermal contact with the mixing chamber 202; a still 204, where the helium-3 in the mixture evaporates from the mixture; and a heat exchanger 206 thermally coupled to the still 204. The MDR 200 further comprises a first microfluidic channel 208 guiding the helium-3 from the heat exchanger 206 to the mixing chamber 202, and a second microfluidic channel 210 guiding the mixture from the mixing chamber 202 to the still 204. The first microfluidic channel 208 is dimensioned to control a flow rate of the helium-3 into the mixing chamber 202. Also shown in FIG. 2 is a pumping system comprised of roughing pump 212 and turbo pump 214 for circulating the helium-3 from the still 204 and back into the mixing chamber 202 via the heat exchanger 206, a dump 216, valves 218, 220 for controlling flow of the helium, and a primary impedance 222. The MDR 200, absent the dump 216, is encased in a 4 K radiation shield 224. Finally, a gold thermalization layer 226 is positioned between the still 204 and heat exchanger 206.

### Example Fabrication Steps

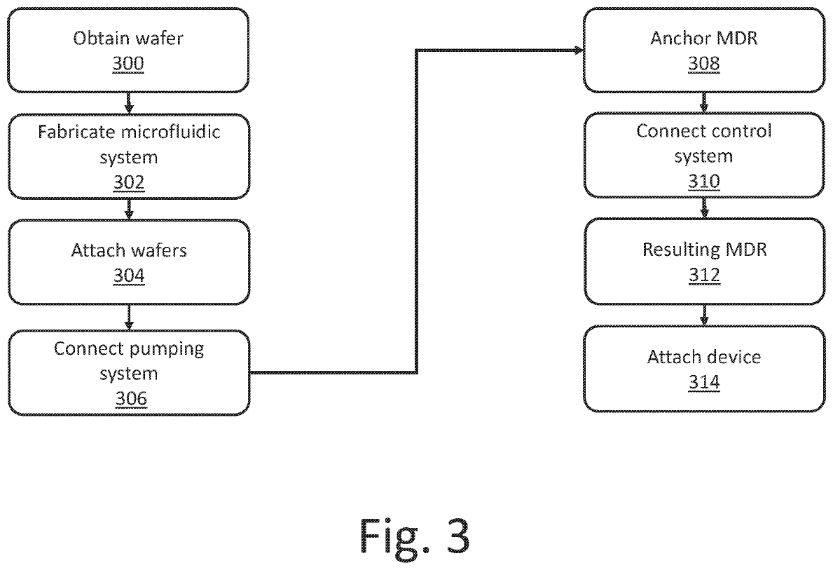

FIG. 3 is a flowchart illustrating a method of making an MDR 200.

Block 300 represents obtaining a wafer. Example materials for the wafer include fused silica (amorphous SiO₂) which is easily etched with standard cleanroom tools and has relatively low thermal conductivity (0.25T^{1.9} mW/(cm K) below 1 K. However, other wafer materials can be used, including those having lower thermal conductivity. In one or more examples, the wafer comprises mainly crystalline quartz irradiated with high energy photons or particles (e.g., such as but not limited to, gamma rays from cobalt 60, or particles such as protons or neutrons) to locally lower thermal conductivity of the wafer to the desired level. The treatment can be applied selectively to different parts to selectively lower the thermal conductivity in different parts of the MDR 200.

Block 302 represents fabricating the microfluidic system of the MDR 200 as an on-chip structure on the wafer, e.g., with lithography, to direct liquids and gasses in a precisely controlled fashion. Processing methods can include those used for manufacturing microfluidic systems in wafers such as fused silica, e.g., as known in the art for fabrication of microfluidic DNA microassays, optofluidics systems, and ink jet printers.

The fabrication step typically comprises etching the elements of a dilution loop in the wafer, so that returning ³He passes through the primary impedance 222 to control the rate of He entering the heat exchanger 206. This is one of the trickiest parts of a conventional dilution refrigerator, usually hand made from a piece of steel wire inserted into a similar diameter capillary tube. In the microfluidic system of the MDR 200 described herein, primary impedance 222 control can be achieved by fabricating a controlled narrow channel of a desired length using the precision of lithography. Plasma-etched through trenches in the silica wafer can thermally isolate the 4 K stage 228 from the still 204, e.g., at a ˜700 mK stage 230.

The heat exchanger 206 is located after the primary impedance 222. The heat exchanger 206 may be designed to operate with the still 204 at mK temperatures (e.g., at the ˜700 mK stage 230) in normal operation. The heat exchanger 206 is further designed to cool down the returning ³He as excessive returning heat inhibits operation of the dilution cooling process. In one or more examples, the heat exchanger 206 is fabricated by creating (e.g., etching) a plurality of SiO₂ nano-posts over a large area of the wafer, and then coating these nanoposts with gold. The gold is also used to form thermal contact to the still 204. In another example, the heat exchanger 206 may comprise nanostructured “black” gold. An active electronic cooler, such as a Normal-Insulator-Superconductor (NIS) tunnel junction [3] (not shown) may be included to assist with the cooling and allow efficient thermalization of the returning gas. The first microfluidic channel 208 between the heat exchanger 206 and the mixing chamber 202 is further dimensioned to thermally isolate this heat exchanger 206 from the mixing chamber 202 at a ˜50 mK stage 232 that follows.

The mixing chamber 202 is formed (e.g., etched) as a large enclosed volume in the chip/wafer, with a second microfluidic channel 210 leaving from the bottom of the mixing chamber 202 and proceeding to the still 204. The mixing chamber 202 is also configured for thermally coupling the device being cooled to the mixture in the mixing chamber 202. To this end, a coupling structure may be formed by creating metal through vias connecting to a metal land on a bottom cover of the mixing chamber 202. The device may then be thermalized to this structure, although care must be taken here to avoid leaks due to differential thermal contraction.

The still 204 in the next 700 mK stage 230 is formed (e.g., etched) as another large enclosed volume in the wafer. The still 204 is configured to enable evaporative cooling of the separated mixture received from the mixing chamber 202. In one or more examples, a small resistive heater (not shown) may be included to promote evaporation of the He so as to increase cooling power. If the MDR 200 is transparent, a laser (not shown) could also be used to deliver heating power to an absorbing metal in the still 204.

In one or more examples, where further tuning or lowering of thermal conductivity is required, additional structures can be formed in the MDR 200, including etching phonon control structures (phononic crystals) into the interstage legs. Alternatively, each stage 228, 230, 232 can be connected to a thin wall stainless or NbTi capillary tubing.

Block 304 represents optionally attaching wafers together if the various components of the MDR 200 (heat exchanger 206, mixing chamber 202, first and second microfluidic channels 208, 210, and still 204) are formed on multiple wafers, and ensuring the wafer connections are leak tight. Such attachment and leak proofing can be achieved using microfluidic processes known in the art, including using polymers, epoxy, metal to metal bonding, and even fusing silica wafers together directly in a precisely controlled oven.

Block 306 represents fabricating and connecting a pumping system comprised of roughing pump 212 and turbo pump 214, for pumping on the still 204 so as to transport the mixture to the 4 K cooling stage 228 and then re-circulate the mixture to the heat exchanger 206. The pumping system comprised of roughing pump 212 and turbo pump 214 is designed so that the pressure of the still 204 is sufficiently low for the dilution effect to operate. In one example, the mixture can be brought to room temperature so that a conventional pumping system can be used. In another example, the pumping is performed on the chip itself, e.g., using a Chip-Scale Vacuum Micro Pump (CSVMP) [4].

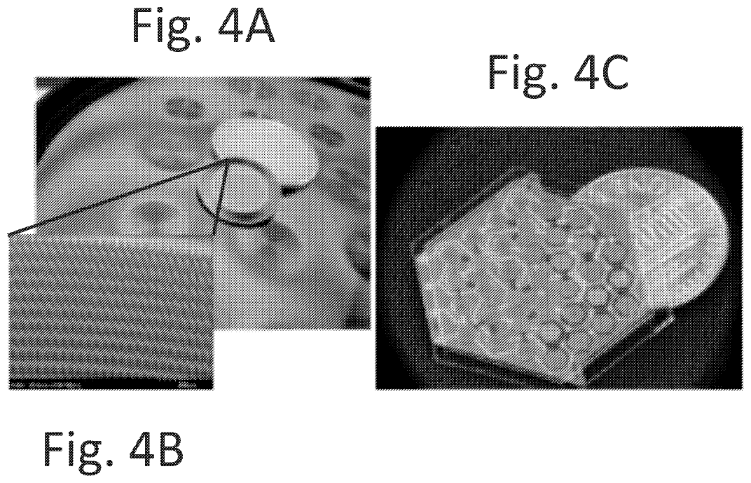

FIGS. 4A, 4B and 4C are images of an on-chip micro-turbo-molecular pump manufactured using silicon micromachining. As shown in FIG. 4A, a pump operating at or near 4 K may comprise a magnetic thin film on the bottom of a turbine rotor so that a superconducting Nb ground plane on the MDR chip can be used to magnetically levitate the rotor. Lithographically defined wire coils around the edge of the pump, as shown in FIG. 4B, can be used to generate magnetic fields used to turn the turbine rotor into the stator of a DC brushless motor, forming an integrated micro-turbo-molecular pump. Such flat motors may be adapted from [5].

Referring again to FIG. 2, the turbo pump 214 is backed up by the roughing pump 212 to keep the pressure on the backside low. In one example, the roughing pump 212 comprises an on-chip Micro-Electro-Mechanical Systems (MEMS) pump, similar to the 24-stage microscale rough pump developed for the CSVMP project. If the power draw of this pump 214 exceeds the cooling power at 4 K (roughly several hundred mW), it could be moved to a higher temperature stage (e.g., 50 K) where higher cooling power is available, and connected to the MDR 200 with CuNi capillary tubing.

Block 308 represents anchoring the entire MDR 200 to an intermediate (e.g. 4 K) stage 228. This intermediate stage 228 can be provided by a mechanical refrigerator, such as a pulse tube or sterling cycle cooler. In another example, the refrigerator for the intermediate stage 228 comprises a compact sterling cycle cooler. e.g., as used in cell-phone base stations with superconducting filters [6], although an intermediate Joule-Thomson stage can also be included to assist with cooling to 4 K. Such sterling cycle coolers can easily fit inside a personal computer case while using power from a standard wall outlet.

Block 310 represents providing a control system for controlling operation of the MDR 200. Starting the dilution cycle is often the most challenging part of running a dilution fridge. The cycle may be initiated by cooling the entire chip/wafer system including the MDR 200 to 4 K inside a metal 4 K radiation shield 224. Any ⁴He exchange gas inside this volume used for rapid cooling can be captured into a charcoal sorption pump (not shown) before the cycle is started. To start the cycle, the mixture must be slowly let into the MDR 200 and boosted to approximately 2 atmospheres so it can condense into a liquid at the 4 K stage 228. For this purpose, the dump 216, which is a tank, is provided and held at a temperature above 4.2 K, and the mixture is slowly and intermittently let in by an on-chip valve 220 to the front side of the roughing pump 212. The roughing pump 212 can be used to boost the mixture to 2 atmospheres, allowing it to condense in the still 204 and mixing chamber 202. Once all the mixture is condensed, the valve 220 will be closed and circulation is allowed to begin. An on-chip valve 218 between the turbo pump 214 and the roughing pump 212 is required to allow pressurization of the mixture for condensation.

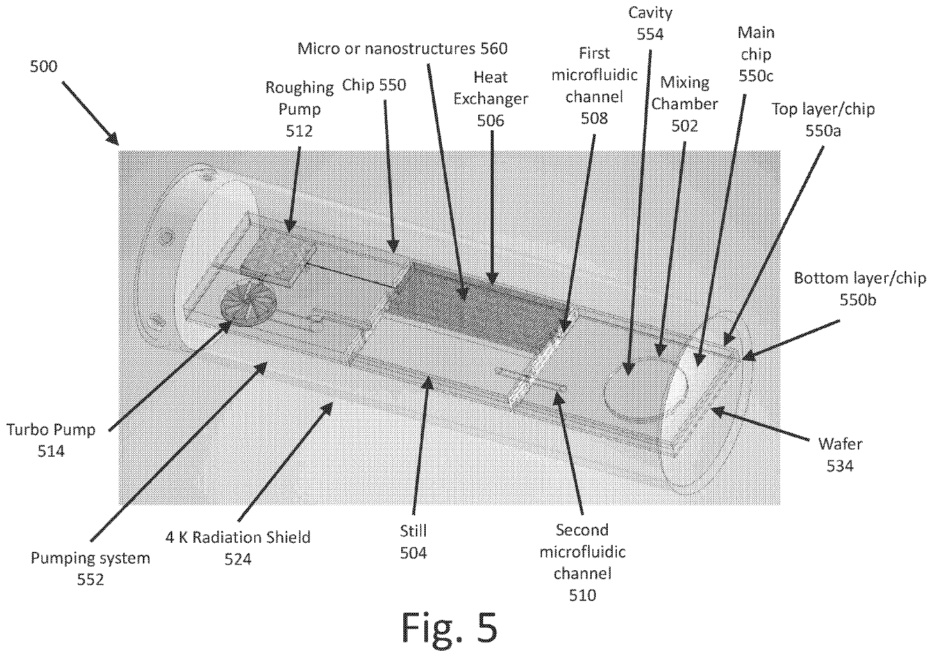

Block 312 represents the end result, an MDR 200. In one example, the MDR 200 comprises a linear arrangement of the components. FIG. 5 is a rendering of a 3D model of an example 80×20×3 mm MDR 500 comprising a stacked arrangement, including a mixing chamber 502, still 504, heat exchanger 506, first microfluidic channel 508, second microfluidic channel 510, roughing pump 512, turbo pump 514, and 4 K radiation shield 524. FIG. 5 illustrates one chip 550 comprising layers comprising a top chip/layer 550a and bottom chip/layer 550b that are wafer bonded to the main chip 550c to seal the channels/pipes 508, 510.

A top cover is omitted for clarity, and the fused silica wafer 534 is rendered for contrast. Small features, like the turbine blades of the turbo pump 514 and the nano-posts of the heat exchanger 506, are rendered much larger than their actual size for clarity. Moreover, the mixing chamber 502 includes a gold coating. In addition, the 4 K radiation shield 524 is shown as transparent.

In this arrangement, each stage is fabricated individually, and then connected with NbTi or stainless capillary tubes to the next stage below it, much like in a conventional dilution refrigerator. Advantages of this configuration include easier thermal isolation, and the ability to customize the fabrication of each stage. A disadvantage is that it is not possible to use the MDR 500 chip itself for lithographed wiring.

Block 314 represents attaching/integration of a device (e.g., quantum device, quantum processor, or Microwave Kinetic Inductance Detector (MKID) camera) or array of devices to the MDR 200. Example methods for attaching the device to the MDR 200 include using an indium ball grid array (BGA) located on each dilution refrigerator stage if a permanent solution is desired, or a Land Grid Array (LGA) type socket similar to those use for modern CPUs for a re-mountable device. This pattern allows the quantum processor to be fit to the MDR 200 at the lowest temperature stage, and for other readout components (such as High Electron Mobility Transistor (HEMT) amplifiers or 4 K Complementary Metal-Oxide-Semiconductor (CMOS) custom Application-Specific Integrated Circuits (ASICs)) to be attached at the higher temperature stages. Wiring can be directly integrated into the bottom cover of the MDR 200 chip, allowing significant wiring density.

Since the thermal mass/heat load of the device being cooled is very small, the MDR 200 can be designed for higher target cooling powers of 10 μW at 100 mK (smaller cooling power than a conventional dilution refrigerator). Moreover, lithographed NbTi wiring also significantly reduces the heat loads. The MDR 200 may be implemented with or without a still 204 shield. Omitting the still 204 shield may prevent reaching the coldest temperatures. Integrating a still 204 shield into the design may enable lower temperatures (<20 mK) to be reached if needed. Moreover, multiple MDRs 200 could be used in parallel to increase cooling power. Adiabatic

Demagnetization Refrigerators (ADRs) have roughly 1 μW of cooling power at 100 mK and are still often used to cool large devices, such as the 20,000 pixel MKID Exoplanet Camera (MEC) at the Subaru Observatory [7].

### Example MDR Coupled to Sorption Pumps

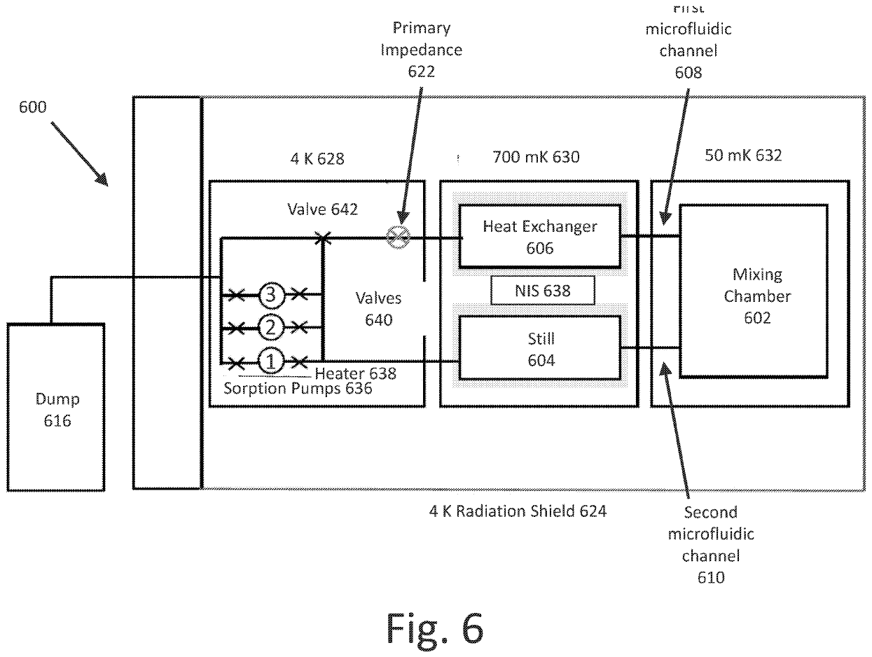

FIG. 6 illustrates another example MDR 600 including a mixing chamber 602, a still 604, a heat exchanger 606, a first microfluidic channel 608, a second microfluidic channel 610, a dump 616, a primary impedance 622, and a 4 K radiation shield 624. In this example, the MDR 600 includes helium sorption pumps 636 (which operate using the properties of a material, such as but not limited to, charcoal which absorbs helium at 4 K but outgasses it readily at higher temperatures), as well as an active electronic cooler such as an NIS tunnel junction 638. FIG. 6 illustrates an example system comprising an MDR 600 coupled to three sorption pumps 636 attached to the 4 K stage 628 with a weak thermal link and further including a resistive heater (not shown). A series of 4 K valves 640, 642 allows one sorption pump 636 to pump on the still 604 until it reaches its storage capacity, and then switches in a second sorption pump 636. The first pump 636 can then be heated to provide the helium-3 to the primary impedance 622. The third sorption pump 636 is added to smooth the delivery of helium-3 by avoiding transients during a switch between the pumps 636.

### Heat Exchanger Performance Analysis

### Perfect Continuous Heat Exchanger Model

Fabrication of the refrigerator would be greatly simplified if a passive, continuous heat exchanger were sufficient to reduce the heat load from the condensed ³He to below that needed to meet the desired performance goals.

In order to place an upper limit on the potential performance of a heat exchanger, a model of a perfect, continuous counterflow heat exchanger solved in [8] was used, comprising a counter-flow exchanger featuring two long channels separated by a thin barrier. This model neglects viscous heat and lateral conduction and assumes that all heat leaving the concentrated phase enters the dilute phase. Their thermodynamic analysis yields the equations:

$${γ}_{C} {T}_{C} \frac{{dT}_{C}}{dx} = {γ}_{D} {T}_{D} \frac{{dT}_{D}}{dx} \qquad ( 1 )$$

$$\text{?} \frac{{dT}_{C}}{dx} = \frac{A}{4 {R}_{3}} ( {T}_{C}^{4} - {T}_{D}^{4} ) \qquad ( 2 )$$

$$\text{?} \text{indicates text missing or illegible when filed}$$

where, x is the coordinate along the length of the heat exchanger, C and I) refer to the concentrated and dilute phases respectively, y=dS/dT, R₃ is the Kapitza resistance coefficient, A is the heat exchanger area, and n is the ³He flow rate. Integrating these equations with T=∞ on the hot side and T=T_{M} on the mixing chamber side yields a set of transcendental equations that can be solved numerically the calculate the performance of the refrigerator. [8] also gives an approximation to the full solution, which will be used for generating plots going forward,

$$\text{?} \approx ( {γ}_{D} - {γ}_{C} ) ( {T}_{m}^{2} - {T}_{00}^{2} ) \qquad ( 3 )$$

$$\text{?} \text{indicates text missing or illegible when filed}$$

where T₀₀ is the base temperature in the absence of a heat leak

$${T}_{00} = \sqrt{\text{?}} \qquad ( 4 )$$

$$\text{?} \text{indicates text missing or illegible when filed}$$

In the presence of a heat leak Qo, [1] substitute the base temperature with

$${T}_{0} = {( {T}_{00}^{2} + \text{?} )}^{1 / 2} \qquad ( 5 )$$

$$\text{?} \text{indicates text missing or illegible when filed}$$

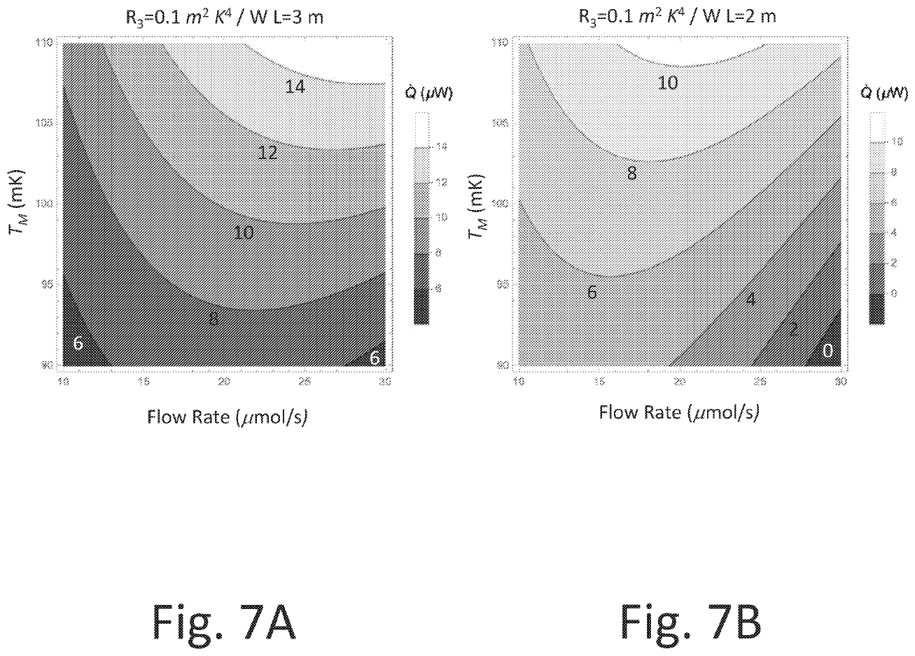

FIGS. 7A and 7B illustrate the cooling power near 100 mK including a heat load from viscous heating. A heat exchanger length of 3 m represents an upper limit of plausibility, while 2 m is more realistic given the original chip dimensions.

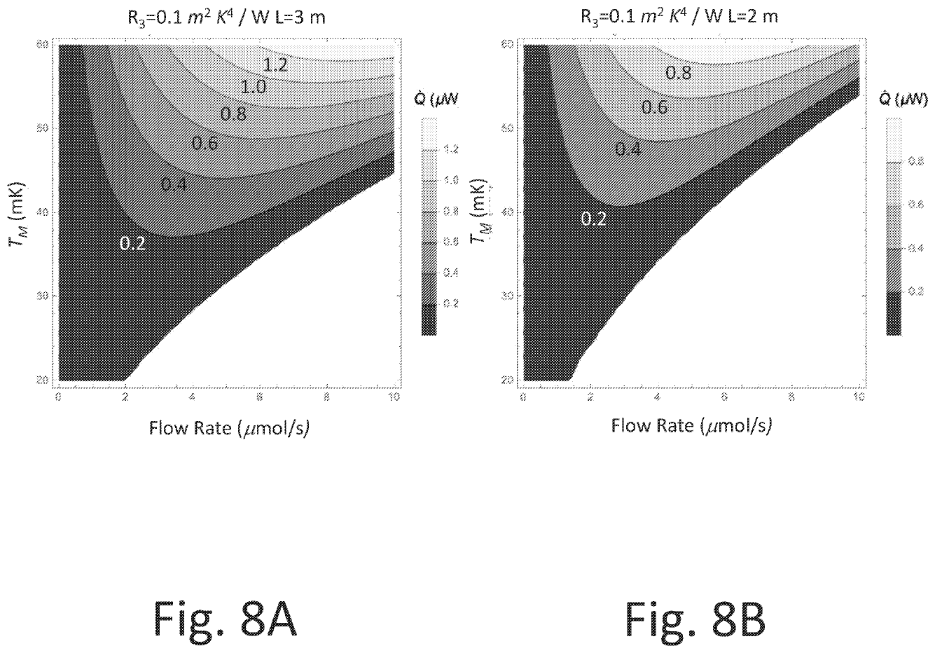

FIGS. 8A and 8B illustrate the cooling power near base temperature for 2 m and 3 m long heat exchangers.

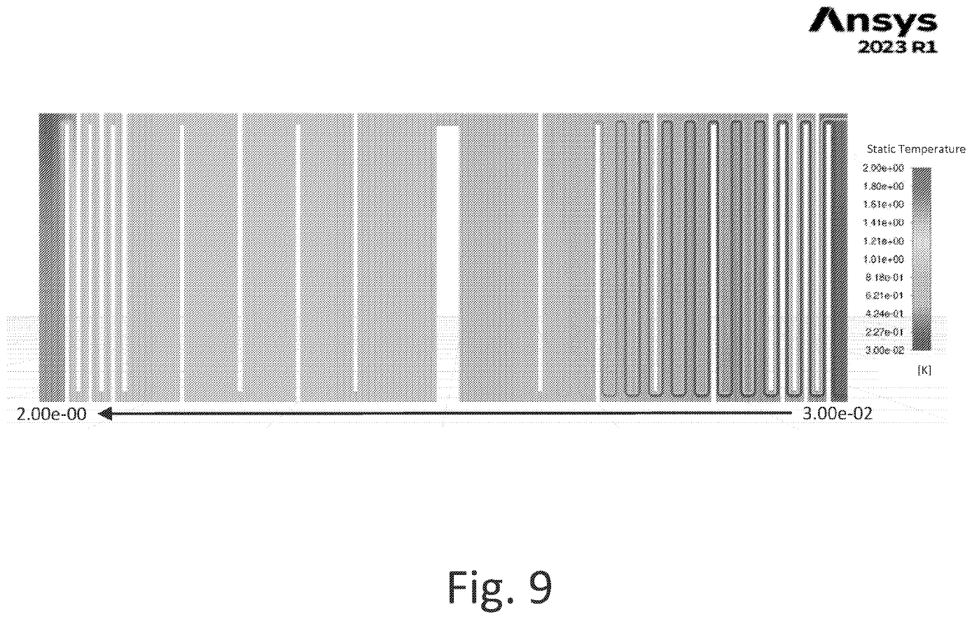

FIG. 9 illustrates a fluent simulation of an approximately 1.2 meter long heat exchanger. T³ Kapitza resistance is crudely included by dividing the heat exchanger into four of different interfacial resistance. The concentrated phase enters at 2 K is cooled to 915 mK by the time it reaches the mixing chamber.

### Device and System Embodiments

Example devices according to embodiments described herein include, but are not limited to, the following (referring also to FIG. 1-9).

1. A microfluidic dilution refrigerator (MDR) 500, comprising:
a microfluidic system comprising:
a mixing chamber 502 wherein helium-3 dissolves in helium-4 to form a mixture absorbing heat, thereby cooling a device when the device is in thermal contact with the mixing chamber (or a mixing chamber configured for, or positioned or dimensioned for dissolving helium 3 in helium 4 to form a mixture, when helium 3 and helium 4 are provided in the mixing chamber);
a still/chamber/cavity 504 wherein the helium-3 in the mixture evaporates from the mixture (or a still/chamber configured for (e.g., positioned and dimensioned to) evaporate the mixture);
a heat exchanger 506 thermally coupled to the still; and
a first microfluidic channel 508 configured for (dimensioned and/or positioned to) guide or couple the helium-3 from the heat exchanger to the mixing chamber, the first microfluidic channel dimensioned to control a flow rate of the helium-3 into the mixing chamber; and
a second microfluidic channel 510 configured for (dimensioned and/or positioned to) guide or couple the mixture from the mixing chamber to the still; and
a pumping system 552 configured for (dimensioned and/or positioned to) circulate the helium-3 from the still and back into the mixing chamber via the heat exchanger.

2. The dilution refrigerator of example 1, further comprising one or more chips 550 or substrates 534 comprising the microfluidic system.

3. The dilution refrigerator of example 2, wherein:
the mixing chamber comprises a first cavity 554 in the one or more chips or substrates,
the still comprises a second cavity in the one or more chips or substrates, and
the first microfluidic channel, the second microfluidic channel, and the heat exchanger are formed in the one or more chips 550 or substrates 534.

4. The dilution refrigerator of example 3, wherein the first cavity, the second cavity, the heat exchanger, the first microfluidic channel, and the second microfluidic channel are lithographically patterned in the one or more chips or substrates.

5. The dilution refrigerator of example 4, wherein:
the heat exchanger comprises an array of micro- or nano-structures 560 formed in the one or more chips or substrates and thermally contacting the still, and
the structures are dimensioned and positioned to guide and thermally contact a flow of the helium-3 from the pumping system through the array and into the second microfluidic channel, so that the heat exchanger transfers heat from the helium-3 to the still, thereby cooling the helium-3 received from the pumping system.

6. The dilution refrigerator of example 5, wherein the structures comprises silicon oxide posts coated with a metal.

7. The dilution refrigerator of any of the example 2-6, wherein the chips or substrates comprise or consist essentially of silicon, silica, or any semiconductor.

8. The dilution refrigerator of any of the examples 1-7, further comprising a cooling system 228, 628 (e.g., comprising a liquid cryogen bath) for providing a first stage of cooling so that the helium-3 can be liquefied in the microfluidic system using the pumping system.

9. The dilution refrigerator of any of the examples 2-8, wherein the pumping system comprises a micro-turbo-molecular pump 514 formed in the one or more chips or substrates.

10. The dilution refrigerator of example 7, wherein the micro-turbo-molecular pump comprises a magnetic rotor levitating over a superconducting ground plane on the one or more chips or substrates.

11. The dilution refrigerator of example 9, wherein the micro-turbo-molecular pump is fed by a first backing pump comprising a MEMS pump 512 formed in the one or more chips or substrates.

12. The dilution refrigerator of any of the examples 1-11, further comprising a bonding material sealing the one or more chips or substrates so as to prevent leakage of the helium-3 from the microfluidic system.

13. The dilution refrigerator of any of the examples 1-12, further comprising a valve 220 and computer 250 for controlling a pressure and a temperature of the helium-3 in the microfluidic system, wherein the computer:
controls the valve 220 to control a flow of the helium-3 and helium-4 into the pumping system from a reservoir 216 containing the helium-3 and helium-4 at the temperature above 4 Kelvin;
controls the pumping system to increase a pressure in the microfluidic system so that the helium-3 and helium-4 condenses as a liquid in the microfluidic system; and
closes the valve to allow the circulating of the helium-3 using the pumping system.

14. The dilution refrigerator of any of the examples 1-13, wherein the microfluidic channels are dimensioned to thermally isolate the mixing chamber from the heat exchanger and the still.

15. The dilution refrigerator of any of the examples 1-14, further comprising a heating system coupled to the still to promote evaporation of the helium-3 from the mixture in the still. In one or more examples, the heating system comprises a resistive heater comprising electrical wires on the portion of the chip 550 coupled to the still cavity and a power supply for supplying current to the wires)

16. The dilution refrigerator of any of the examples 1-15, further comprising a mount for thermally coupling a device to the mixing chamber, e.g., comprising indium bump bonds for electrical connections and gold wire bonds for thermal connections.

17. The dilution refrigerator of any of the examples 1-16, configured such that a temperature T of the mixing chamber is such that k_{B}T is less than an excitation energy for manipulating a qubit using the device.

18. The dilution refrigerator of any of the examples 1-17, wherein the device mounted to the MDR comprises a quantum sensor or a quantum processor in a quantum computer for performing operations on a qubit.

19. The dilution refrigerator of any of the examples 16-18, wherein the mount comprises a land grid array, a ball grid array, wire bonds, or pogo pins on the one or more chips or substrates comprising the mixing chamber.

20. The dilution refrigerator of any of the examples 1-19, wherein the mixing chamber, the still, the heat exchanger, the first microfluidic channel, and the second microfluidic channel each have a length, width and depth in a range of 1 nm-1000 micrometers.

21. The dilution refrigerator of example 20, wherein the structures in the heat exchanger have a diameter, height, and spacing in a range of 1 nm-1000 micrometers.

22. A MDR comprising, or the dilution refrigerator of any of the examples 1-21, wherein the one or more chips or substrates comprising the mixing chamber, the still, the heat exchanger, the microfluidic channels, and the pumping system, consist of or comprise at least 50% crystalline quartz where selected parts of the crystalline quartz is treated with radiation to locally lower thermal conductivity to a desired level (e.g., similar to or lower than 0.25T^{1.9} mW/(cm K) below 1 K).

23. The dilution refrigerator 600 of any of the examples 1-22, further comprising:
a 4 Kelvin (4 K) stage 628 (e.g., comprising or coupled to a mechanical refrigerator):

a first sorption pump 636 (1) and a second sorption pump 636 (2) attached to the 4 K stage with a weak thermal link; and a series of valves 640:
allowing the first sorption pump to pump on the still by absorbing helium-3 until it reaches its storage capacity, collecting absorbed helium-3, and
then switching in the second pump;
a primary impedance valve 622 connecting the sorption pumps to the heat exchanger;
a heater 638 heating the first sorption pump so that the first absorption pump outputs the absorbed helium-3 to the primary impedance valve; and
a third sorption pump 636 (3) connected to smooth delivery of the absorbed helium-3 by avoiding transients during the switching between the first sorption pump and the second sorption pump.

24. A computer or controller coupled to the valves of example 23 to control opening and closing of the valves and operation of the heater.

25. A microfluidic dilution refrigerator comprised mainly of crystalline quartz where selected irradiation of parts of the device locally lower thermal conductivity.

26. The microfluidic dilution refrigerator of any of the examples 2-25, wherein the chips or substrates comprising the microfluidic system are comprised mainly of crystalline quartz, where selected irradiation of parts of the chips or substrates locally lower thermal conductivity to a desired level (e.g., no more than 0.25T^{1.9} mW/(cm K) below 1 K).

27. The MDR of any of the examples 1-26, wherein the computer controlling the MDR (e.g., controlling the pressure, temperature by controlling the heaters or opening and closing of the valves) comprises one or more integrated circuits, one or more microprocessors or microcontrollers, one or more application specific integrated circuits, or one or more field programmable gate arrays coupled to the MDR, or a computer comprising one or more processors; one or more memories; and an application stored in the one or more memories, wherein the application executed by the one or more processors controls the valves and/or heaters as described herein.

28. The MDR of any of the examples, wherein a still is defined as a chamber coupled to a heater for evaporating mixture in the chamber and also having a pipe going to the mixing chamber.

### REFERENCES

The following publications are incorporated by reference herein.
[1] Zheng, M. et al. A Brief Review of Dilution Refrigerator Development for Space Applications. Journal of Low Temperature Physics 197, 1-9 (2019).
[2] Convery, N. & Gadegaard, N. 30 years of microfluidics. Micro and Nano Engineering 2, 76-91 (2019).
[3] Clark, A. M. et al. Cooling of bulk material by electron-tunneling refrigerators. Applied Physics Letters 86, 173508 (2005).
[4] Grzebyk, T. Mems vacuum pumps. Journal of Microelectromechanical Systems 26, 705-717 (2017).
[5] Merzaghi, S., Koechli, C. & Perriard, Y. Development of a hybrid mems bldc micromotor. IEEE Transactions on Industry Applications 47, 3-11 (2011).
[6] Glaister, D. S., Gully, W., Ross, R. G., Stack, R. & Marquardt, E. Ball aerospace 4-10 k space cryocoolers. In Ross. R. G. (ed.) Cryocoolers 13, 1-7 (Springer US, Boston, MA, 2005).
[7] Walter, A. B. et al. The mkid exoplanet camera for subaru scexao. Publications of the Astronomical Society of the Pacific 132, 125005 (2020).
[8] Y. Takano. Cooling power of the dilution refrigerator with a perfect continuous counterflow heat ex-changer. Review of Scientific Instruments, 65(5):1667-1674, 05 1994.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A microfluidic dilution refrigerator, comprising:
a microfluidic system including:
a mixing chamber wherein helium-3 dissolves in helium-4 to form a mixture absorbing heat, thereby cooling a device in thermal contact with the mixing chamber;
a still wherein the helium-3 in the mixture evaporates from the mixture;
a heat exchanger thermally coupled to the still;
a first microfluidic channel positioned to guide the helium-3 from the heat exchanger to the mixing chamber, the first microfluidic channel dimensioned to control a flow rate of the helium-3 into the mixing chamber;
a second microfluidic channel positioned to guide the mixture from the mixing chamber to the still; and
a pumping system positioned to circulate the helium-3 from the still and back into the mixing chamber via the heat exchanger.

2. The microfluidic dilution refrigerator of claim 1, further comprising one or more chips or substrates comprising the microfluidic system.

3. The microfluidic dilution refrigerator of claim 2, wherein:
the mixing chamber comprises a first cavity in the one or more chips or substrates,
the still comprises a second cavity in the one or more chips or substrates, and
the first microfluidic channel, the second microfluidic channel, and the heat exchanger are formed in the one or more chips or substrates.

4. The microfluidic dilution refrigerator of claim 3, wherein the first cavity, the second cavity, the heat exchanger, the first microfluidic channel, and the second microfluidic channel are lithographically patterned in the one or more chips or substrates.

5. The microfluidic dilution refrigerator of claim 4, wherein:
the heat exchanger comprises an array of micro- or nano-structures formed in the one or more chips or substrates and thermally contacting the still, and
the structures are dimensioned and positioned to guide and thermally contact a flow of the helium-3 from the pumping system through the array and into the second microfluidic channel, so that the heat exchanger transfers heat from the helium-3 to the still, thereby cooling the helium-3 received from the pumping system.

6. The microfluidic dilution refrigerator of claim 5, wherein the structures comprises silicon oxide posts coated with a metal.

7. The microfluidic dilution refrigerator of claim 2, wherein the chips or substrates comprise or consist essentially of silicon, silica, or any semiconductor.

8. The microfluidic dilution refrigerator of claim 7, wherein the micro-turbo-molecular pump comprises a magnetic rotor levitating over a superconducting ground plane on the one or more chips or substrates.

9. The microfluidic dilution refrigerator of claim 1, further comprising a cooling system for providing a first stage of cooling so that the helium-3 can be liquefied in the microfluidic system using the pumping system.

10. The microfluidic dilution refrigerator of claim 1, wherein the pumping system comprises a micro-turbo-molecular pump formed in the one or more chips or substrates.

11. The microfluidic dilution refrigerator of claim 10, wherein the micro-turbo-molecular pump is fed by a first backing pump comprising a micro electromechanical systems (MEMS) pump formed in the one or more chips or substrates.

12. The microfluidic dilution refrigerator of claim 1, further comprising a bonding material sealing the one or more chips or substrates so as to prevent leakage of the helium-3 from the microfluidic system.

13. The microfluidic dilution refrigerator claim 2, wherein the one or more chips or substrates comprising the mixing chamber, the still, the heat exchanger, the microfluidic channels, and the pumping system, consist of or comprise at least 50% crystalline quartz where selected parts of the crystalline quartz is treated with radiation to locally lower thermal conductivity to a desired level.

14. The microfluidic dilution refrigerator of claim 1, further comprising a valve and computer for controlling a pressure and a temperature of the helium-3 in the microfluidic system, wherein the computer:
controls the valve to control a flow of the helium-3 and helium-4 into the pumping system from a reservoir containing the helium-3 and helium-4 at the temperature above 4 Kelvin;
controls the pumping system to increase a pressure in the microfluidic system so that the helium-3 and helium-4 condenses as a liquid in the microfluidic system; and
closes the valve to allow the circulating of the helium-3 using the pumping system.

15. The microfluidic dilution refrigerator of claim 1, wherein the microfluidic channels are dimensioned to thermally isolate the mixing chamber from the heat exchanger and the still.

16. The microfluidic dilution refrigerator of claim 1, further comprising a heating system coupled to the still to promote evaporation of the helium-3 from the mixture in the still.

17. The microfluidic dilution refrigerator of claim 1, further comprising a mount for thermally coupling the device to the mixing chamber.

18. The microfluidic dilution refrigerator of claim 17, wherein the mount comprises a land grid array, a ball grid array, wire bonds, or pogo pins on the mixing chamber.

19. The microfluidic dilution refrigerator of claim 1, configured such that a temperature T of the mixing chamber is such that k_{B}T is less than an excitation energy for manipulating a qubit using the device.

20. The microfluidic dilution refrigerator of claim 1, wherein the device comprises a quantum sensor or a quantum processor in a quantum computer for performing operations on a qubit.

21. The microfluidic dilution refrigerator of claim 1, wherein the mixing chamber, the still, the heat exchanger, the first microfluidic channel, and the second microfluidic channel each have a length, width and depth in a range of 1 nm-1000 micrometers.

22. The microfluidic dilution refrigerator of claim 20, wherein structures in the heat exchanger have a diameter, height, and spacing in a range of 1 nm-1000 micrometers.

23. The microfluidic dilution refrigerator of claim 1, further comprising:
a 4 Kelvin (4 K) stage;
a first sorption pump and a second sorption pump attached to the 4 K stage with a weak thermal link; and
a series of valves:
allowing the first sorption pump to pump on the still by absorbing helium-3 until it reaches its storage capacity, collecting absorbed helium-3, and then switching in the second pump;
a primary impedance valve connecting the sorption pumps to the heat exchanger;
a heater heating the first sorption pump so that the first absorption pump outputs the absorbed helium-3 to the primary impedance valve; and
a third sorption pump connected to smooth delivery of the absorbed helium-3 by avoiding transients during the switching between the first sorption pump and the second sorption pump.
